(19) United States
(12) Patent Application Publication
(10) Pub. No.: US 2004/0181024 A1
(43) Pub. Date: Sep. 16, 2004

(54) Polypropylene-based resin composition for a metallized film, film using the same to be subject to metallizing and metallized film using the same

(76) Inventors: Yasunori Nakamura, Yokkaichi-shi (JP); Hiroshi Ohmori, Yokkaichi-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/629,857

(22) Filed: Jul. 30, 2003

(30) Foreign Application Priority Data
Jul. 30, 2002 (JP) 2002-222112
Jul. 24, 2003 (JP) 2003-279212

(51) Int. Cl. C08F 10/00

(52) U.S. Cl. 526/348.1; 524/502; 524/430

(57) ABSTRACT

A polypropylene-based resin composition for metallized films, comprising (A) 100 parts by weight of a propylene random copolymer having an MFR_{A} of 1 to 30 g/10 minutes, PI of 2.4 to 4, solubles contained at 20° C. or lower at 1.5% by weight or less and solubles contained at 40° C. or lower at 4.0% by weight or less, (B) 0.01 to 6 parts by weight of a polyethylene resin having a density of 0.945 to 0.980 g/cm³ and MI_{B} of 1 to 1000 g/10 minutes, (C) 0.01 to 0.7 parts by weight of an antiblocking agent having an average particle size of 1.0 to 5.0 μm and pore volume of 1.7 mL/g or less, (D) 0.01 to 0.5 parts by weight of an antioxidant having a molecular weight of 500 or more and (E) 0.005 to 0.5 parts by weight of a hydrotalcite-based compound, and the metallized film of the same composition, excellent in processability, stiffness, heat-sealing property, resistance to blocking and surface scratching, containing a limited quantity of solubles, excellent in adhesion properties of the metallizing film to the base film, printability and lamination characteristics of the metallized surface.

### BACKGROUND OF THE INVENTION

1. Field of the Invention

The present invention relates to a metallized film excellent in processability, stiffness, heat-sealing property, resistance to blocking and surface scratching, adhesion properties of the metallizing film to the base film, and printability and lamination characteristics of the metallized surface; film for metallization, which can give the metallized film; and polypropylene-based resin composition for metallized films.

2. Description of the Prior Art

Films of propylene random copolymer have been used in wide areas, e.g., food wrapping films and containers, for their well-balanced properties among strength, stiffness, transparency and resistance to impact, among others. Of these, the films for food wrapping are metallized for the areas which need a gas barrier property, because they are inherently gas-permeable. In particular, aluminum-metallized films have been used in wide areas, centered by wrapping.

A propylene random copolymer for these films is generally incorporated with a neutralizer, and also with a slipping agent for film processability and handleability. These films involve problems resulting from the additive incorporated therein, e.g., neutralizer, slipping agent or antioxidant, e.g., migration of the additive towards the film surface, and transfer of the additive or the like, which has migrated towards the surface, to another laminated film surface. Some additives may reduce wetting tension of the metallized surface, even in a trace quantity, causing problems, e.g., greatly deteriorated printability of the metallized surface or adhesion properties of the metallizing film to another film. These additives include fatty acid derivatives, in particular metallic salts of higher fatty acids, e.g., calcium stearate and sodium stearate which are used as neutralizers for acidic components in residual catalysts in polymer; and fatty acid derivatives, e.g., amide of higher fatty acids including oleic amide, stearic amide, erucic amide and ethylene bis stearo amide which are normally used as slipping agents for films. A propylene film free of the above additive may encounter a number of problems in the film molding or film post-processing step.

For example, the film free of a slipping agent may have greatly lowered slippage or resistance to blocking, to be furrowed when wound or to cause local swelling of the film roll, deteriorating its wound conditions or greatly deteriorating film processability. These adverse phenomena are more noted when a propylene random copolymer is used, because of its insufficient stiffness and excessive tackiness, resulting in lowered film productivity and yield. Even when the furrow- or swell-free portion is metallized, the above problems will still occur during the metallized film winding step, further deteriorating processability of the metallized film. These phenomena tend to be more noted as melting point of the copolymer decreases.

Some metallized polypropylene films have been proposed to solve these problems. For example, a film of a composition incorporated with a specific high-density polyethylene or film of a composition incorporated with zeolite particles is metallized (disclosed by, e.g., Patent Document 1 or 2). However, these metallized films, although excellent in adhesion properties of the metallizing film to the base film or showing limited decrease in wetting tension of the metallized surface, may have lowered resistance to surface scratching, roughened film surface to deteriorate film smoothness or metallic gloss, or defects, e.g., fisheyes or pinholes.

Recently, metallized films of propylene random copolymer, produced in the presence of a metallocene catalyst to have specific properties, have been proposed (disclosed by, e.g., Patent Documents 3 and 4).

However, the inventors of the present invention have tested these films to find that the propylene random copolymer produced in the presence of a metallocene catalyst to have specific properties involves problems, e.g., transcription of sweeper roll marks onto the film when it is made into a film by a T die to further aggravates the furrows or swells.

As discussed above, there is no metallized propylene film which can satisfy all of the characteristics of excellent processability, stiffness, heat-sealing property, adhesion properties to the metallizing film, and printability and lamination characteristics of the metallized surface. Therefore, there are great demands for metallized propylene films which can satisfy all of the characteristics of excellent processability, stiffness, heat-sealing property, adhesion properties to the metallizing film, and printability and lamination characteristics of the metallized surface.

Patent Document 1

Japanese Patent Laid-open Publication No.59-25829

Patent Document 2

Japanese Patent Examined Publication No.61-16617

Patent Document 3

Japanese Patent Laid-open Publication No.11-263812

Patent Document 4

Japanese Patent Laid-open Publication No.2002-128923

### SUMMARY OF THE INVENTION

It is an object of the present invention to provide a metallized film excellent in processability, stiffness, heat-sealing property, resistance to blocking and surface scratching, containing a limited quantity of solubles, and excellent in adhesion properties to the metallizing film, and printability and lamination characteristics of the metallized surface. It is another object of the present invention to provide a film for metallization, which can give the metallized film. It is still another object of the present invention to provide a polypropylene-based resin composition for metallized films.

The inventors of the present invention have found, after having extensively studied, that a polypropylene-based resin composition comprising a propylene random copolymer having specific properties, incorporated with a specific polyethylene resin, antiblocking agent, antioxidant and hydrotalcite-based compound can solve the above problems, and suitable for production of a metallized film excellent in processability, stiffness, heat-sealing property, resistance to blocking and surface scratching, containing a limited quantity of solubles, and excellent in adhesion properties to the metallizing film, and printability and lamination characteristics of the metallized surface, achieving the present invention.

The first aspect of the present invention provides a polypropylene-based resin composition for metallized films, comprising:

(A) 100 parts by weight of a propylene random copolymer having the properties (a-1) to (a-5):

(a-1) propylene unit present at 88 to 99.5% by mol, and ethylene and/or butene structural unit present at 0.5 to 12% by mol,

(a-2) melt flow rate (MFR_{A}) of 1 to 30 g/10 minutes,

(a-3) polydispersity index (PI), determined by the melt viscoelasticity analysis, of 2.4 to 4,

(a-4) solubles contained at 20° C. or lower, determined by cross fractionation chromatography (CFC), at 1.5% by weight or less, and the solubles having a weight-average molecular weight of 0.1×10⁴ to 6.0×10⁴, and

(a-5) solubles contained at 40° C. or lower, determined by cross fractionation chromatography (CFC), at 4.0% by weight or less, and the solubles having a weight-average molecular weight of 0.1×10⁴ to 8.0×10⁴,

(B) 0.01 to 6 parts by weight of a polyethylene resin having a density of 0.945 to 0.980 g/cm³, melt index (MI_{B}) of 1 to 1000 g/10 minutes, and ratio of MI_{B} to MFR_{A}, i.e., (MI_{B}/MFR_{A}) ratio, of 0.7 to 1000,

(C) 0.01 to 0.7 parts by weight of an antiblocking agent having an average particle size of 1.0 to 5.0 μm and pore volume of 1.7 mL/g or less,

(D) 0.01 to 0.5 parts by weight of an antioxidant having a molecular weight of 500 or more, and

(E) 0.005 to 0.5 parts by weight of a hydrotalcite-based compound.

The second aspect of the present invention provides the polypropylene-based resin composition of the first aspect for metallized films, wherein the propylene random copolymer (A) further has the property (a-6), and antiblocking agent (C) has a pore volume of 0.45 mL/g or more and wear rate of 100 mg or less:

(a-6) melting point (Tp), determined by differential scanning calorimetry (DSC), of 115 to 150° C.

The third aspect of the present invention provides the polypropylene-based resin composition of the first or second aspect for metallized films, wherein the antioxidant (D) is a phenol- and/or phosphorus-based one.

The fourth aspect of the present invention provides the polypropylene-based resin composition of one of the first to third aspects for metallized films, wherein the propylene random copolymer (A) is produced in the presence of a metallocene catalyst.

The fifth aspect of the present invention provides a film for metallization, composed of the polypropylene-based resin composition of one of the first to fourth aspects for metallized films.

The sixth aspect of the present invention provides the film of the fifth aspect for metallization, satisfying the following relationship:

730≦14×[HST]−[YM]≦1340 (1)

(wherein, [HST] is a heat seal temperature (unit: ° C.) at which the load is 3N, and [YM] is a tensile modulus (unit: MPa) of the film).

The seventh aspect of the present invention provides a metallized film of the film of the fifth or sixth aspect for metallization, metallized with a metal and/or its oxide.

### DETAILED DESCRIPTION OF THE INVENTION

1. The Polypropylene-based Resin Composition for Metallized Films

(A) Propylene Random Copolymer

The propylene random copolymer for the present invention is a random copolymer of propylene, ethylene and/or butene. More specifically, those useful for the present invention include random copolymers of propylene and ethylene, propylene and butene, and 3-component copolymer of propylene, ethylene and butene.

The propylene random copolymer for the present invention have the following properties (a-1) to (a-5), and, as required, the property (a-6).

(a-1) Propylene Unit, Ethylene Unit and/or Butene Unit

The propylene random copolymer for the present invention should contain the propylene unit at 88 to 99.5% by mol, preferably 90 to 99%, more preferably 92 to 98.5%; and ethylene and/or butene unit at 0.5 to 12% by mol, preferably 1 to 10%, more preferably 1.5 to 8%. The propylene unit, when present at below 88% by mol, may not render the film a sufficient stiffness and suitable resistance to blocking, and, when present at above 99.5% by mol, may deteriorate low-temperature heat-sealing property of the film. The propylene, ethylene and butene unit are determined by Fourier transform infrared spectrometry.

(a-2) Melt Flow Rate (MFR_{A})

The propylene random copolymer for the present invention has a melt flow rate (MFR_{A}, determined in accordance with JIS K-6921-2 at 230° C. and a load of 21.18N) of 1 to 30 g/10 minutes, preferably 2 to 20 g/10 minutes, more preferably 4 to 15 g/10 minutes. Suitable productivity of the film may not be secured when the copolymer has an MFR_{A} below the above range, because of insufficient extrudability. On the other hand, the film may not have a sufficient strength when it has an MFR_{A} exceeding the above range. The desired MFR_{A} level can be realized by controlling, as required, polymerization temperature, catalyst charge rate, supply rate of hydrogen as a molecular weight adjustor, or the like.

(a-3) Polydispersity Index (PI)

The propylene random copolymer for the present invention has a polydispersity index (PI), determined by the melt viscoelasticity analysis, of 2.4 to 4, preferably 2.4 to 3.5, more preferably 2.6 to 3.5, viewed from limited transcription of sweeper roll marks to secure excellent processability, and well-balanced film properties and adequate metallization. The film may have deteriorated extrudability to make film-making process difficult when the copolymer has a PI level below 2.4. On the other hand, the film may have insufficient surface conditions and deteriorated transparency when it has a PI level above 4. The copolymer satisfying the PI limitation means that it has a molecular weight distribution index in a specific range, and has a broader molecular weight distribution than the conventional one having a narrow distribution, which is one of the characteristics of the polymer produced in the presence of a metallocene catalyst. PI is one of the physical properties traditionally used in the related industry to represent viscoelastic characteristics of high-molecular-weight polymers. Japanese Patent Laid-open Publication No.2000-336217, for example, describes its definition and analytical procedure, and PI for the present invention is defined in the same manner. Its analytical procedure is described below.

PI is an index for representing molecular weight distribution, and introduced by G. R. Zeichner et al (G. R. Zeichner and P. D. Patel, Pros. of the 2^{nd} World Congress of Chem. Eng., Canada, 1981).

It is given by the relationship PI=10⁵/G_{CO}, wherein G_{CO} is elastic modulus under a measurement condition (angular frequency ω) at which storage elastic modulus G′ is equal to loss elastic modulus G″. More specifically, G_{CO} is determined by the following procedure.

First, G′ and G″ are plotted against angular frequency ω. Three (3) measurement points, with the point closest to the point at which the condition G′>G″ is reversed to the one G′<G″ as the center are selected, and used for calculating the G′-G″″ intersection coordinates. These 3 points are approximated by the following quadratic functions:

lnG′=a(lnω)²+b(lnω)+c

lnG″=d(lnω)²+e(lnω)+f

wherein, the constants “a” to “f” are determined by the least square method. The X abscissa of the intersection is given by the following formula:

$$X = ln ω = \frac{- ( b - e ) + \sqrt{{( b - e )}^{2} - 4 ( a - d ) ( c - f )}}{2 ( a - d )}$$

and G_{CO} (which is equal to G′ and G″) is given by the formula:

G_{CO}=exp[aX²+bX+c]

Unit of G_{CO} is pascal, and PI is dimensionless.

PI is more suitable for representing molecular weight distribution of polymer than the one determined by size exclusion chromatography (hereinafter referred to as SEC) for a low-molecular-weight component having a molecular weight of 5000 or less, which is difficult to measure by SEC, or a high-molecular-weight component having a molecular weight of 1,000,000 or more, which is unsuitable for SEC analysis due to limitations set by exclusion volume of the column.

It was determined by a dynamic viscoelasticity analyzer (Rheometric, RDA-II), where the sample was frequency-swept on parallel plates (diameter: 25 mm, thickness: 1.8 mm) at 200° C. and a strain of 15%. Dynamic viscoelasticity (G′ and G″″) were determined in an angular frequency range from 500 to 0.05 rad/second at intervals of 5 points for one digit.

(a-4) Solubles Determined 20° C. or Lower by Cross Fractionation Chromatography (CFC)

The propylene random copolymer for the present invention contains solubles at 20° C. or lower, determined by cross fractionation chromatography (CFC), at 1.5% by weight or less, preferably 1.2% or less, more preferably 1.0% or less. The solubles should have a weight-average molecular weight of 0.1×10⁴ to 6.0×10⁴, preferably 0.1×10⁴ to 5.0×10⁴, more preferably 0.1×10⁴ to 4.0×10⁴, particularly preferably 0.1×10⁴ to 3.0×10⁴. When it contains solubles at 20° C. or lower at above 1.5% by weight and the solubles having a molecular weight above 6.0×10⁴, it is of a low-crystalline component and difficult to evaporate with the result that it may remain on the metallized surface to possibly exert adverse effects on printability or lamination of the metallized surface. When it contains solubles at 20° C. or lower at above 1.5% by weight and the solubles having a molecular weight below 0.1×10⁴, it tends to evaporate during the molding step to excessively emit fume.

(a-5) Solubles Contained at 40° C. or Lower, Determined by CFC

It is important that the propylene random copolymer for the present invention contains solubles at 40° C. or lower, determined by CFC, at 4.0% by weight or less, preferably 3% or less, more preferably 2.5% or less. The solubles should have a weight-average molecular weight of 0.1×10⁴ to 8.0×10⁴, preferably 0.1×10⁴ to 7.0×10⁴, more preferably 0.1×10⁴ to 6.0×10⁴, particularly preferably 0.5×10⁴ to 4.0×10⁴. When it contains solubles at 40° C. or lower at above 4.0% by weight and the solubles having a molecular weight above 8.0×10⁴, the film may have a low-crystalline component difficult to evaporate remaining on the surface while it is stored, which may deteriorate its blocking resistance or exert adverse effects on adhesion of the metallized film. When it contains solubles at 40° C. or lower at above 4.0% by weight and the solubles having a molecular weight below 0.1×10⁴, it tends to evaporate during the molding step to excessively emit fume.

The solubles at 20° C. or lower or 40° C. or lower contains the so-called low-crystalline component, e.g., a low-molecular-weight component (e.g., oligomer), component of low stereoregularity (e.g., atactic polypropylene) or component containing a comonomer at an extremely high content. The component of low stereoregularity (e.g., atactic polypropylene) and component containing a comonomer at an extremely high content may be soluble, even when they have a high molecular weight. For the copolymer to be useful for the present invention, it should contain the solubles at a limited content and, at the same time, the solubles having a molecular weight in a specific range. In order to produce the copolymer useful for the present invention, therefore, it is necessary to avoid a catalyst or polymerization process which gives a polypropylene of broad compositional distribution to contain a polypropylene of low stereoregularity or low-crystalline component containing a comonomer at an extremely high content.

CFC, which is a combination of temperature rise elution fractionation (TREF) and gel permeation chromatography (GPC), can measure polymer crystallinity distribution and molecular weight distribution simultaneously. In the analysis, the sample solution of polypropylene completely dissolved in a solvent is injected, while being kept at high temperature, into a column filled with an inert carrier, e.g., glass beads, and deposited on the filler surfaces by decreasing column temperature. Then, column temperature is gradually increased, while o-dichlorobenzene is passed through the column, to measure polypropylene concentration of each sample fraction eluted out at each temperature level. At the same time, each fraction is passed on-line to the GPC column, where the molecular weight and molecular weight distribution of each component are estimated from the chromatogram. The component is eluted out at higher temperature as its crystallinity increases, based on which the polymer crystallinity distribution can be measured from the relationship between elution temperature and polymer quantity (% by weight) eluted out.

In the above procedure, it is essential to keep column temperature decreasing rate at a level necessary for crystallizing each crystallizable component in polypropylene in the sample at each temperature, and column temperature rising rate at a level necessary for completing dissolution of each eluting component at each temperature. The column temperature decreasing and increasing rates are determined by the preliminary test. The analysis was carried out under the following conditions:

Analyzer Mitsubishi Chemical, CFC T150A

Detector MIRAN, 1A infrared spectrometer (measurement frequency: 3.42 μm)

Solvent O-dichlorobenzene

Flow rate 1 mL/minute

Measurement concentration 3 mg/mL

TREF column

Inert carrier (glass beads, 0.1 mm in diameter)

Column size: 0.46 cm in diameter, 15 cm long

GPC column

Showa Denko, AD806M/S, 3 columns

(The column was calibrated with monodisperse polystyrene solutions (Tosoh, A500, A2500, F1, F2, F4, F10, F20, F40 and F288, 0.5 mg/mL each), where eluted volume and molecular weight were approximated by a quadratic equation in a log-log plot. Molecular weight of the sample was as polypropylene, determined using viscosity equations for polystyrene and polypropylene with the coefficients α=0.723 and logK=−3.967 for polystyrene and α=0.707 and logK=−3.616 for polypropylene).

The column kept at 140° C. was charged with 0.4 mL of the sample polymer and then cooled at 140° C./160 minutes to 0° C. to be adsorbed (deposited) on the filler surface. The components not adsorbed on the filler surface but kept dissolved in the solvent at this point of time were defined as the solubles contained at 0° C. or lower, and passed on-line to the GPC column, where the sample was fractionated by molecular weight and eluted quantity was determined by the infrared detector. The solubles contained at 20° C. or lower were defined as those insoluble contained at 20° C. or lower, including those soluble at 0° C. or lower, and determined by accumulating the soluble components collected at each temperature rise step until the column was heated to 20° C. Similarly, the solubles contained at 40° C. or lower were defined as those soluble at 40° C. or lower, including those soluble at 0° C. or lower, and determined by accumulating the soluble components collected at each temperature rise step until the column was heated to 40° C.

(a-6) Melting Point (Tp)

The propylene random copolymer for the present invention has a melting point (Tp) of 115 to 150° C., preferably 120 to 145° C., more preferably 125 to 140° C. The copolymer having a melting point below the above range may not render the film a sufficient stiffness and suitable resistance to blocking, and that having a melting point exceeding the above range may deteriorate low-temperature heat-sealing property of the film.

Melting point (Tp) was determined by differential scanning calorimetry (DSC) using an analyzer (SEIKO), where approximately 5 mg of the sample was collected, held at 200° C. for 5 minutes, and cooled at 10° C./minute up to 40° C. It was then heated at 10° C./minute, to determine Tp from the fusion heat curve established when it was molten. More specifically, Tp was defined as temperature at which a maximum was observed in the curve.

The propylene random copolymer for the present invention is produced preferably in the presence of a metallocene catalyst under the normally adopted conditions, as discussed later. The metallocene catalyst comprises a compound of transition metal (Group 4 metal in the periodic table) containing a ligand of cyclopentadienyl structure, promoter and, as required, organoaluminum compound supported by a carrier. It preferably has 2 or more compounds of transition metals (Group 4 metals in the periodic table) each containing a ligand of specific cyclopentadienyl structure, in order to control the PI level more easily, and hence produce the desired film more easily.

The cyclopentadienyl structure in the transition metal (Group 4 metal in the periodic table) containing a ligand of cyclopentadienyl structure means cyclopentadienyl group, substituted cyclopentadienyl group or the like. The substituted cyclopentadienyl groups useful for the present invention include those having at least one substituent selected from the group consisting of hydrocarbon group of 1 to 30 carbon atoms, and silyl, silyl-substituted alkyl, silyl-substituted aryl, cyano, cyanoalkyl, cyanoaryl, halogen, haloalkyl and halosilyl groups. The substituted-cyclopentadienyl group may have 2 or more substituents. These substituents may be bound to each other to form a ring structure. Moreover, the rings may each formed by the substituents bound to each other may share a substituent.

The hydrocarbon groups of 1 to 30 carbon atoms include alkyl, cycloalkyl, aryl and aralkyl. More specifically, they include alkyl groups, e.g., methyl, ethyl, n-propyl, isopropyl, n-butyl, isobutyl, sec-butyl, t-butyl, pentyl, hexyl, octyl, 2-ethylhexyl and decyl; cycloalkyl groups, e.g., cyclopentyl and cyclohexyl; aryl groups, e.g., phenyl and tolyl; and aralkyl groups, e.g., benzyl and neophyl.

The substituted-cyclopentadienyl groups with the substituents (i.e., hydrocarbon groups) bound to each other to form one or more rings include indenyl group, indenyl group substituted with a hydrocarbon group (e.g., alkyl group) of 1 to 20 carbon atoms, naphthyl group, naphthyl group substituted with a hydrocarbon group (e.g., alkyl group) of 1 to 8 carbon atoms, fluorenyl group, fluorenyl group substituted with a hydrocarbon group (e.g., alkyl group) of 1 to 8 carbon atoms, and azulenyl group, azulenyl group substituted with a hydrocarbon group (e.g., alkyl group) of 1 to 20 carbon atoms.

The transition metals of Group 4 in the periodic table for the compounds containing a ligand of cyclopentadienyl structure include zirconium, titanium and hafnium, of which zirconium is particularly preferable. These transition metal compounds normally have 1 to 3 ligands having cyclopentadienyl structure. When 2 or more ligands are present, they may be bound to each other via a crosslinking group. The crosslinking groups useful for the present invention include alkylene of 1 to 4 carbon atoms, dialkyl silylene and dialkyl germylene. The representative ligands other than those having cyclopentadienyl structure for the compounds of transition metals (Group 4 metals in the periodic table) include hydrogen, hydrocarbon group (e.g., alkyl, alkenyl, aryl, alkylaryl, aralkyl or polyenyl) of 1 to 20 carbon atoms, halogen, metaalkyl group and metaaryl group.

The compounds of transition metals (Group 4 metals in the periodic table) containing a ligand of cyclopentadienyl structure include the following compounds as non-restrictive examples. These compounds, merely denoted by their chemical names, have an asymmetric steric structure defined for the present invention, needless to say. These are only zirconium compounds, but those having hafnium in place of zirconium are also useful for the present invention.

Dimethylsilylenebis{1-(2-methyl-4-phenyl-4H-azulenyl)}zirconium dichloride,

dimethylsilylenebis[1-{2-methyl-4-(4-chlorophenyl)-4H-azulenyl}]zirconium dichloride,

dimethylsilylenebis[1-{2-methyl-4-(4-fluorophenyl)-4H-azulenyl}]zirconium dichloride,

dimethylsilylenebis[1-{2-methyl-4-(3-chlorophenyl)-4H-azulenyl}]zirconium dichloride,

dimethylsilylenebis[1-{2-methyl-4-(2-methylphenyl)-4H-azulenyl}]zirconium dichloride,

dimethylsilylenebis[1-{2-methyl-4-(1-naphthyl)-4H-azulenyl}]zirconium dichloride,

dimethylsilylenebis[1-{2-methyl-4-(2-naphthyl)-4H-azulenyl}]zirconium dichloride,

dimethylsilylenebis[1-{2-methyl-4-(4-t-butylphenyl)-4H-azulenyl}]zirconium dichloride,

dimethylsilylenebis[1-{2-methyl-4-(4-fluoro-1-naphthyl)-4H-azulenyl}]zirconium dichloride,

dimethylsilylenebis[1-{2-methyl-4-(4-fluoro-2-naphthyl)-4H-azulenyl}]zirconium dichloride,

dimethylsilylenebis{1-(2-ethyl-4-phenyl-4H-azulenyl)}zirconium dichloride,

dimethylsilylenebis[1-{2-ethyl-4-(4-chlorophenyl)-4H-azulenyl}]zirconium dichloride,

dimethylsilylenebis[1-{2-ethyl-4-(4-fluorophenyl)-4H-azulenyl}]zirconium dichloride,

dimethylsilylenebis[1-{2-ethyl-4-(2-methylphenyl)-4H-azulenyl}]zirconium dichloride,

dimethylsilylenebis[1-{2-ethyl-4-(1-naphthyl)-4H-azulenyl}]zirconium dichloride,

dimethylsilylenebis[1-{2-ethyl-4-(1-anthracenyl)-4H-azulenyl}]zirconium dichloride,

dimethylsilylenebis[1-{2-ethyl-4-(1-phenanthryl)-4H-azulenyl}]zirconium dichloride,

dimethylsilylenebis{1-(2-dimethylborano-4-indolyl-4H-azulenyl)}zirconium dichloride, dimethylsilylenebis{1-(2-methyl-4,5-benzoindenyl)}zirconium dichloride and dimethylsilylenebis{1-(2-methyl-4-phenylindenyl)}zirconium dichloride.

These compounds of transition metals (Group 4 metals in the periodic table) containing a ligand of cyclopentadienyl structure may be used either individually or in combination as the catalyst component. It is preferable to use a mixture of 2 or more of these compounds of different hydrogen response, because an individual compound alone may not satisfy the PI requirement for the present invention.

The promoter to be used in combination with the compound of transition metal (Group 4 metal in the periodic table) containing a ligand of cyclopentadienyl structure means the one serviceable as a polymerization catalyst for the compound of transition metal, or capable of balancing the catalytically activated ionic charge. The promoters useful for the present invention include benzene-soluble aluminoxane of organoaluminiumoxy compound, benzene-insoluble organoaluminiumoxy compound, ion-exchangeable layered silicate, boron compound, lanthanoid salt, e.g., lanthanum oxide, and tin oxide.

The compound of transition metal (Group 4 metal in the periodic table) containing a ligand of cyclopentadienyl structure may be supported by a carrier of organic or inorganic compound. The carrier is preferably a porous oxide of inorganic or organic compound. More specifically, the carriers useful for the present invention include an ion-exchangeable layered silicate, e.g., montmorillonite, SiO₂, Al₂O₃, MgO, ZrO₂, TiO₂, B₂O₃, CaO, ZnO, BaO, ThO₂ and a mixture thereof.

The organoaluminum compounds which may be used as required include trialkyl aluminum, e.g., triethyl aluminum, triisopropyl aluminum and triisobutyl aluminum; dialkyl aluminum halide; alkyl aluminum sesqui-halide; alkyl aluminum dihalide; alkyl aluminum hydride; and organoaluminum alkoxide.

Any polymerization process can be used, so long as each monomer can be brought into contact efficiently with the catalytic component. More specifically, the processes useful for the present invention include the slurry process in which an inert solvent is used, bulk process in which propylene is used as a solvent while an inert solvent is essentially absent, solution process, and vapor-phase process in which each monomer is essentially kept gaseous while a liquid solvent is essentially absent.

(B) Polyethylene-based Resin

The polyethylene resin for the present invention is a homopolymer of ethylene, or ethylene/α-olefin copolymer of 3 or more carbon atoms with ethylene as the major ingredient (ethylene content: preferably 90% by mol or more), including a modified polyethylene grafted with carboxylic acid or the like.

The polyethylene resin for the present invention has a density of 0.945 to 0.980 g/cm³, preferably 0.945 to 0.970 g/cm³, more preferably 0.945 to 0.965 g/cm³. The resin having a density below 0.945 g/cm³ may not sufficiently protect the film from sweeper roll marks transcribed thereto, and also may not give a sufficient stiffness to the film. On the other hand, the resin having a density above 0.980 g/cm³ may not give a sufficient impact strength to the film.

The polyethylene resin for the present invention has a melt index (MI_{B}, determined in accordance with JIS K-6922-2 at 190° C. and a load of 21.18N) of 1 to 1000 g/10 minutes, preferably 2 to 800 g/10 minutes, more preferably 4 to 500 g/10 minutes. The resin having an MI_{B} level below 1 g/10 minutes may give the film with greatly deteriorated surface smoothness, and also deteriorated gloss or brightness of the metallized surface. On the other hand, the resin having an MI_{B} level above 1000 g/10 minutes may give the metallized film with insufficient adhesion properties of the metallizing film to the base film, or printability or lamination property, resulting from elution of the low-molecular-weight component on the surface.

It is essential that ratio of melt index (MI_{B}) of the polyethylene resin to MFR_{A} of the propylene random copolymer, i.e., (MI_{B}/MFR_{A}) ratio, is 0.7 to 1000, preferably 1.0 to 400, more preferably 1.3 to 125. The ratio below 0.7 is undesirable, because it may cause greatly deteriorated smoothness of the film, and deteriorated gloss or brightness of the metallized surface. On the other hand, the ratio above 1000 may cause insufficient adhesion properties to the metallizing film, or printability or lamination property of the metallized film, resulting from elution of the low-molecular-weight component on the surface.

Combining the propylene random copolymer with the polyethylene resin in such a way to have the (MI_{B}/MFR_{A}) ratio in the above range is preferable, viewed from finely dispersed polyethylene resin in the film, efficiently controlling transcription of sweeper roll marks to the film, and particularly well-balanced characteristics of the metallized surface.

The process and catalyst for producing the polyethylene resin for the present invention are not limited, so long as the polymer satisfying the required properties is produced. However, the polyethylene resin produced by the intermediate-pressure process is suitable.

The catalysts useful for the present invention include Ziegler catalyst (comprising a combination of halogen-containing titanium compound, which may be supported or not supported, and organoaluminum compound), and Kaminsky catalyst (comprising a combination of metallocene catalyst, which may be supported or not supported, and organoaluminum compound, in particular alumoxane).

(C) Antiblocking Agent

The antiblocking agent for the present invention has an average particle diameter of 1.0 to 5.0 μm, preferably 1.5 to 4.5 μm, more preferably 2.0 to 4.0 μm. The agent having an average particle diameter below 1.0 μm may give the film of insufficient resistance to blocking, resulting from insufficient surface roughness, and also may cause the wound film to be furrowed or swollen. On the other hand, the agent having an average particle diameter above 5.0 μm is also undesirable, because it may give the film or metallized film of insufficient resistance to surface scratching, resulting from excessive surface roughness.

The average particle diameter is determined by a Coulter counter.

The antiblocking agent for the present invention has a pore volume of 1.7 mL/g or less, preferably 0.45 to 1.7 mL/g, more preferably 0.8 to 1.6 mL/g, particularly preferably 1.0 to 1.6 mL/g. The antiblocking agent having a pore volume below 0.45 mL/g will be excessively hard, and is not always desirable because it may cause the film or metallized film surface to be scratched. On the other hand, the agent having a pore volume above 1.7 mL/g may be insufficiently dispersible, possibly causing the film to have deteriorated outer appearances. Pore volume is considered to represent structure of the primary particles. The primary particles have surface energy increasing with pore volume, and tend to be more agglomerated each other while being incorporated in the propylene polymer.

The pore volume is determined by the nitrogen adsorption method.

The antiblocking agent for the present invention preferably has a wear rate of 100 mg or less, determined using a plastic wire, more preferably 80 mg or less, still more preferably 50 mg or less. The agent having a wear rate above 100 mg is not always desirable because it may cause the film or metallized film surface to be scratched. The wear rate, determined using a plastic wire, is used as an index representing hardness of the agent, and analyzed by the following procedure.

The antiblocking agent sample was prepared in the form of slurry of given concentration, and worn by a wear tester (Nippon Filcon) for 3 hours under the following conditions, and dried at 80° C. for 10 minutes, to measure weight loss of the wire:

| | |
|---|---|
| Slurry concentration: | 2%, 400 g/20 L |
| Flow rate: | 0.65 L/minute |
| Roll: | Ceramic A roll, 60 mm in diameter |
| Roll speed: | 1500 rpm |
| Contact angle: | 111° |
| Weight: | 850 g |
| Wire: | Plastic wire (of polyester) |

The antiblocking agent for the present invention is not limited, so long as it has properties in the above. One or more agents may be used. It may be organic or inorganic. The organic agents useful for the present invention include polymethyl methacrylate, polymethylsilyl sesqui-oxane (silicone), polyamide, polytetrafluoroethylene, epoxy resin, polyester resin, benzoguanamine, formaldehyde resin and phenol resin. The inorganic agents useful for the present invention include calcium carbonate, calcium nitrate, barium sulfate, calcium phosphate, silica, clay, talc and mica. The inorganic agent is more preferable in consideration of the balance among dispersibility of the agent itself, transparency and resistance to blocking of the film, and resistance to surface scratching of the film or metallized film surface. Silica, in particular synthetic silica, is more preferable, where it contains silicon dioxide at 40% by weight or more in its crystalline structure, preferably 50 to 100%. It may contain another element, e.g., magnesium, calcium, aluminum or the like in the form of magnesium silicate, aluminum silicate, calcium aluminum silicate or the like.

The antiblocking agent for the present invention may be incorporated with one or more surface treatment agents so long as it keeps the required properties. These agents include surfactant, metallic soap, organic acids (e.g., acrylic acid, oxalic acid, citric acid and tartaric acid), higher alcohol, ester, silicone, fluorine resin, silane coupling agent, condensed phosphates (e.g., sodium metaphosphate, sodium pyrophosphate, sodium tripolyphosphate and sodium trimetaphosphate), pH adjustor, and organic stabilizer. Of these, organic salts, in particular citric acid, are more preferably used for the treatment. The treatment method is not limited, and known ones (e.g., surface spraying and immersion) can be used.

The antiblocking agent may take any fine shape. It may be spherical, angular, columnar, needle-shape, plate-shape or undefined shape, of which spherical and undefined shape are more preferable for their well-balanced properties and high dispersibility. Undefined shape is particularly preferable.

(D) Antioxidant

The antioxidant for the present invention has a molecular weight of 500 or more, preferably 600 or more, more preferably 700 or more. The one having a molecular weight below 500 is undesirable, because it tends to transfer or be evaporated excessively, to deteriorate adhesion properties to the metallizing film, or printability or lamination property of the metallized surface. The antioxidant for the present invention is not limited, and may be phenol-, phosphorus- or sulfur-based. However, it is preferably phenol- or phosphorus-based. The antioxidants may be used either individually or in combination.

More specifically, the antioxidants having a molecular weight of 500 or more include

tetrakis-[methylene-3-(3′,5′-di-t-butyl-4′-hydroxyphenyl)propionate]methane, 1,3,5-trimethyl-2,4,6-tris(3,5-di-t-butyl-4-hydroxybenzyl)benzene,

3,9-bis[2-{3-(3-t-butyl-4-hydroxy-5-methylphenyl)propionyloxy}-1,1-dimethy lethyl]-2,4,8,10-tetrakis pyro[5,5]undecane,

1,3,5-tris(4-t-butyl-3-hydroxy-2,6-dimethylbenzyl)isocyanurate,

6-(4-hydroxyl-3,5-di-t-butylamino)-2,4-bis-n-octylthio-1,3,5-triazine,

1,1,3-tris(2-methyl-4-hydroxy-5-t-butylphenyl)butane,

tris(3,5-di-t-butyl-4-hydroxyphenyl)isocyanurate,

tetrakis(2,4-di-t-butylphenyl)4,4′-biphenylene-diphosphonite and

tris-(2,4-di-t-butylphenyl)phosphite.

(E) Hydrotalcite Compound

The hydrotalcite compounds useful for the present invention include hydrotalc as a natural mineral salt and synthetic hydrotalcite, the latter being more preferable for its dispersibility and neutralizing effect. The hydrotalcite compound useful for the present invention is not limited, and some examples include Mg-Al, Zn-Al and Li-Al hydrotalcite compounds.

The commercial hydrotalcite compounds include DHT-4A, DHT-4A-2, DHT-4C, ZHT-4A, ZHT-4D, ALCAMIZER-1, ALCAMIZER-2, Kyoword 500, Kyoword 1000, Kyoword 2000, Kyoword 2100 and Kyoword 2200 (all supplied by Kyowa Chemical Industry).

Particle diameter of these hydrotalcite compounds is not limited, and any diameter may be used within limits not harmful to the object of the present invention. However, it is normally 10 μm or less, preferably 5 μm or less, more preferably 3 μm or less. Their relative BET surface area is 1 to 50 m²/g, particularly preferably 3 to 20 m²/g, viewed from their dispersibility and neutralizing effect, and also from outer appearances and uniformity of the resulting film.

Next, content of each component for the polypropylene-based resin composition of the present invention for metallized films is described.

The polyethylene resin is incorporated in the film at 0.01 to 6 parts by weight per 100 parts by weight of the propylene random copolymer, preferably 0.05 to 4 parts, more preferably 0.1 to 3 parts. The polyethylene resin, when incorporated at below 0.01 parts by weight, may not provide a sufficient effect of controlling transcription of sweeper roll marks to the film. Such a low content is also undesirable, viewed from insufficient stiffness of the film. The content above 6 parts by weight is also undesirable, because the film incorporated with the resin at such a high content may have roughened surface with fisheye-like irregularities, or greatly deteriorated brightness or gloss when metallized to lose the metallic feeling. The content of 0.1 to 3 parts by weight is more preferable for particularly excellent moldability of the film composition, and balanced characteristics of the metallized film, described above.

The antiblocking agent is incorporated in the film at 0.01 to 0.7 parts by weight per 100 parts by weight of the propylene random copolymer, preferably 0.03 to 0.5 parts, more preferably 0.05 to 0.3 parts. The antiblocking agent, when incorporated at below 0.01 parts by weight, may not provide suitable film resistance to blocking because of insufficient surface irregularities, or may cause the wound film to be furrowed or swollen. The content above 0.7 parts by weight is also undesirable, because the film incorporated with the agent at such a high content may have excessive irregularities on the surface, or deteriorated resistance to surface scratching before or after being metallized.

The antioxidant is incorporated in the film at 0.01 to 0.5 parts by weight per 100 parts by weight of the propylene random copolymer, preferably 0.03 to 0.3 parts, more preferably 0.04 to 0.2 parts. The antioxidant, when incorporated at below 0.01 parts by weight, may not fully exhibit its antioxidant capacity. The composition incorporated with the antioxidant at such a low content may not be well made into a film. The content above 0.5 parts by weight is also undesirable, because the film incorporated with the agent at such a high content may have deteriorated adhesion properties to the metallizing film, or printability or lamination property of the metallized surface.

The hydrotalcite compound is incorporated in the film at 0.005 to 0.5 parts by weight per 100 parts by weight of the propylene random copolymer, preferably 0.01 to 0.3 parts, more preferably 0.02 to 0.2 parts. The hydrotalcite compound, when incorporated at below 0.005 parts by weight, may not fully exhibit its effect of neutralizing hydrochloric acid or the like present in the resin, to cause aging-induced corrosion of the resin or coloration of the film. When incorporated at above 0.5 parts by weight, on the other hand, it may not be uniformly dispersed in the film, with the result that the film may not have good outer appearances, because of deteriorated gloss or the like. Therefore, the content beyond the above range is undesirable.

The polypropylene-based resin composition of the present invention for metallized films may be incorporated with one or more other additives, within limits not harmful to the object of the invention. These additives include nucleating agent, weather stabilizer, antistatic agent, slipping agent, antifogging agent, colorant and elastomer. The composition is incorporated with one or more of these additives normally by a kneader, where all of the components for the composition are molten under heating at 190 to 350° C., and then pelletized to prepare the mixture for molding.

2. Film

The film of the present invention for metallization has excellent processability, stiffness, heat-sealing property, resistance to blocking and surface scratching, and, when metallized, has the surface of excellent adhesion properties to the metallizing film, and printability and lamination characteristics of the metallized surface by use of the polypropylene-based resin composition containing the specific components described above. The film preferably satisfies the relationship (1), described below, for further improved stiffness and heat-sealing property:

730≦14×[HST]−[YM]≦1340 (1)

(wherein, [HST] is a heat seal temperature (unit: ° C.) at which the load is 3N, and [YM] is a tensile modulus (unit: MPa) of the film). More preferably, it satisfies the relationship 1165≦17×[HST]−[YM]≦1670, still more preferably 1310≦18×[HST]−[YM]≦1780.

[HST] is a heat seal temperature (unit: ° C.) at which the load is 3N, where the two films of the present invention were heat-sealed to prepare the 15 mm wide-sample under the conditions of sealing pressure: 0.2 MPa and sealing time: 0.5 seconds in the direction perpendicular to the MD direction in which the films were melt-extruded, and were then pulled from each other in the MD direction at a tensile speed of 500 mm/minute to be separated at a load of 3N; and [YM] is a tensile modulus (unit: MPa) in the MD direction, determined in accordance with ISO-R1184.

2.1 Film Production

The film of the present invention for metallization is produced by extruding the polypropylene resin composition of the present invention. The composition can be made into the film by the known method, e.g., T-die or tubular method. The film is produced under the condition for quenching the melt-extruded composition at 70° C. or lower, preferably 50° C. or lower. When quenched at above 70° C., the film tends to be very fragile and deteriorated in heat-sealing property at low temperature, and hence difficult to satisfy the above relationship.

The film thus produced is preferably surface-treated by a known method, e.g., treatment with corona discharge, flame or plasma, to further improve adhesion properties.

The surface treatment may be carried out in a suitable stage after the film is produced and before it is metallized. However, the film is most simply treated before it is wound during the film-making step. It is preferably treated to an extent to have a wetting tension of 37 dynes/cm or more, determined in accordance with JIS K-6758, particularly preferably 39 dynes/cm or more. The film may be anchor-coated on the treated side with a thin film of adhesive, e.g., polyester-, polyurethane- or epoxy-based resin, to adhere the metal faster to the film.

2.2 Film Metallization

The metallized polypropylene film can be produced by metallizing the film under a vacuum on the treated side.

The method for metallizing the film of the composition of the present invention with a metal or its oxide is normally based on the vacuum evaporation, in which a filament on which an objective metal, e.g., aluminum, nickel, gold, silver, or oxide thereof, is deposited is heated under a vacuum (10⁻⁴ to 10⁻⁵ Torr or so) in a vacuum metallizing chamber equipped with a film sending, metallizing, winding device and the like to melt/evaporate the metal or its oxide, and the film moving on the film sending device is continuously metallized with the evaporated molecules and wound. The Film can be also metallized by sputtering which uses scattering of a metal or its oxide serving as a cathode, a phenomenon observed when discharge is caused under a vacuum, or ion plating.

The metals with which the film is metallized include aluminum, gold, silver, copper, nickel, chromium, germanium, titanium, selenium, tin and zinc, of which aluminum is more preferable viewed from the overall considerations of workability, economic efficiency and productivity, among others. The composition of the present invention is particularly effective with aluminum, and is most useful not only for improving metallizing treatability and productivity but also for the object of the present invention, which is aimed at improvement of adhesion properties to the metallizing film, and brightness, printability and lamination property of the metallized film.

Thickness of the metallized film can be varied depending on specific purposes. In the case of film, its thickness is normally tens to hundreds angstrom (Å), preferably 200 to 700 Å for adhesion properties and durability.

One of the very effective methods is metallization of a laminate on the composition of the present invention serving as one surface layer or the other surface layer of another composition. Particularly useful is metallization of a co-extruded laminate on the surface layer of another composition of crystallizable polypropylene-based resin having a crystal melting point above 150° C.

### EXAMPLES

The present invention is described in detail by EXAMPLES and COMPARATIVE EXAMPLES, which by no means limit the present invention, and variations may be made without departing the scope of the present invention.

The film properties were determined in EXAMPLES by the following analytical procedures. The propylene random polymers were prepared in PRODUCTION EXAMPLES 1 to 8 for EXAMPLES.

(Film Evaluation Procedure)

(1) Evaluation of Sweeper Roll Marks (SWR Marks)

Whether sweeper roll marks were transcribed to the film surface was evaluated according to the following standards:

⊚: No sweeper roll marks are observed

∘: Some sweeper roll marks are observed, but to an extent not harmful to the present invention

x: Sweeper roll marks are clearly observed to an extent harmful to the present invention

(2) Haze (Unit: %)

A primary film (i.e., film not metallized) was analyzed by a haze meter in accordance with JIS K-7136-2000. A film having a lower haze value means it is more transparent.

(3) Film Outer Appearances

A primary film was visually observed. Its outer appearances were evaluated according to the following standards:

∘: (Good outer appearances): Fine flickers are not observed, indicating that the film is uniformly dispersed with the antiblocking agent.

x: (Defective outer appearances): A number of fine flickers resulting from insufficient dispersion of the antiblocking agent or fisheyes resulting from agglomeration of the antiblocking agent are observed.

(4) Blocking Properties

Two 2 cm wide, 15 cm long samples of a primary film were placed one on another with the corona-treated sides in contact with each other for a length of 5 cm (contact area: 10 cm²), left at 40° C. for 24 hours under a load of 0.5N/cm² to adjust their conditions, sufficiently kept at 23° C. after the load was released, and tested by a Schopper tensile tester at 500 mm/minute, to determine a force (unit: g/10 cm²) required for separating them from each other under the shear stress. A film is more resistant to blocking when it has a lower force. ps (5) Tensile Modulus (Unit: MPa)

A primary film was analyzed for tensile modulus in the direction in which the film was melt-extruded (MD direction) by an Instron autograph in accordance with ISO R-1184. A film is stiffer when it has a higher tensile modulus.

(6) Heat-sealing Property (HS Property)

Two 15 mm wide samples of a primary film were placed one on another with the corona-untreated sides in contact with each other to be sealed in the direction perpendicular to the MD direction in which the films were melt-extruded under the conditions of heat seal pressure: 0.2 MPa and heat seal time: 0.5 seconds at a given temperature level using a 5 by 200 mm heat seal bar, and pulled from each other in the MD direction by a Schopper tensile tester at 500 mm/minute, to measure the load. The heat-sealing property was evaluated by heat seal temperature (° C.) at which the load reached 3N. A film is higher in heat-sealing property when it has a lower seat seal temperature.

(7) Film Wound Condition

The primary film and metallized film of given length were continuously wound, to visually observe the film roll. The film wound condition was evaluated according to the following standards:

∘: (Good wound condition): The film surface is flat, without being furrowed or swollen.

x: (Defective wound condition): The film is furrowed or swollen.

(8) Resistance to Surface Scratching

An aluminum-metallized film was analyzed for gloss (G₁) of the metallized surface in accordance with ASTM D-523. Next, the film was placed on a sled with the non-metallized side out, and another film was placed on a table with the metallized side up, on which the sled was moved in accordance with ASTM D-1894 (sled load: 22N). Portion of the metallized side over which the sled was passed was analyzed for gloss (G₂). Resistance to surface scratching was evaluated by ΔG (G₁-G₂, unit: %). A film is more resistant to surface scratching it has a lower ΔG value.

(9) Adhesion Properties to the Metallizing Film

A 18 mm wide Cellophane adhesive tape (Sekisui, Cellotape R) was put on the metallized layer on an aluminum-metallized film for a length of 70 mm, and then quickly peeled off by fingers, to measure area ratio of the metallized layer remaining on the film, i.e., the layer not deposited on the tape). The film was ranked according to the following standards:

∘: (Good adhesion properties): Ratio of the remaining metallized layer area: 90 to 100%

x: (Insufficient adhesion properties): Ratio of the remaining metallized layer area: less than 90%

(10) Printability of the Metallized Surface

Two aluminum-metallized films were put one on another with the metallized surface on the side not metallized, to which a load of 10N/100 cm² was applied, and left in an atmosphere kept at 40° C. and RH of 95% for 72 hours, to measure wetting tension (dynes/cm) of the metallized surface. A film should have a wetting tension of 35 dynes/cm or more to be evaluated that it has good printability.

(11) Lamination Property of the Metallized Surface

An aluminum-metallized film was coated with a corona-treated, biaxially stretched PP (BOPP) film (thickness: 20 μm) via a polyester-based adhesive (Toyo Morton, spread at 2.5 g/m²) by dry lamination, where the PP film was pressed at 60° C. and 50N/cm². The coated film was aged at 40° C. for 48 hours, and analyzed for peel strength in the interface at 90° by a tensile tester, after the adhesive was completely solidified.

(Production Example 1 for Producing Propylene Polymer)

(1) Preparation of Chemically Treated, Ion-exchangeable, Layered Silicate

A 10L glass-made separable flask equipped with an agitator blade was slowly charged with 3.75L of distilled water and then with 2.5 kg of concentrated sulfuric acid (96%). The content was dispersed with 1 kg of montmorillonite (Mizusawa Industrial Chemicals, BENCLAY® SL) and heated to 90° C., at which it was held for 6.5 hours. The resulting slurry was cooled to 50° C., and filtered under a vacuum. The recovered cake was slurried again with 7L of distilled water, and filtered. This washing procedure was repeated until pH level of the wash liquid (filtrate) exceeded 3.5. The recovered cake was dried at 110° C. in a nitrogen atmosphere through the night, to obtain 705 g of the chemically treated silicate.

The silicate thus produced was further dried by a kiln drier. The drier and drying conditions are summarized below:

Drier

Equipped with a rotary cylinder (inner diameter: 50 mm), humidification zone (electric oven, 550 mm long) and scraper blade (rotational speed: 2 rpm, angle of inclination: 20/520)

Drying Conditions

Silicate feed rate: 2.5 g/minute, Gas (nitrogen) flow rate: 96L/hour, Silicate and nitrogen were flown countercurrently. Drying temperature: 200° C. (powder temperature)

(2) Preparation of Catalyst

A 13L (inner volume) metallic reactor equipped with an agitator was charged with a mixture of the dried silicate (0.20 kg) prepared above and heptane (Nisseki-Mitsubishi, 0.74L) and then with 1.26L of 0.04M heptane solution of tri-n-octyl aluminum, and kept at 25° C. The reaction was allowed to proceed for 1 hour, and the effluent was thoroughly washed with heptane, to prepare 2.0L of the silicate slurry.

A mixture of (r)-dimethylsilylenebis[1-{2-methyl-4-(4-chlorophenyl)-4H-azulenyl}]zirconium dichloride (0.869 g, 1.20 mmols), (r)-dimethylsilylenebis[1-{2-methyl-4-(3-chlorophenyl)-4H-azulenyl}]zirconi um dichloride (1.23 g, 1.80 mmols) and heptane (0.80L) was prepared, to which 33.1 mL of 0.71M heptane solution of triisobutyl aluminum was added. The reaction was allowed to proceed at room temperature for 1 hour, and the silicate slurry was added to the effluent. The mixture was stirred for 1 hour, to which heptane was added to 5.0L.

Propylene was added to the above mixture at 100 g/hour at 40° C. for the preliminary polymerization, which was continued for 4 hours. Then, the polymerization was further carried out for another 1 hour. On completion of the preliminary polymerization, the residual monomer was removed, and the catalyst was thoroughly washed with heptane. The effluent was incorporated with 0.17L of a heptane solution of triisobutyl aluminum, and dried under a vacuum at 45° C., to prepare 0.60 kg of the dried, preliminary polymerized catalyst.

(3) Polymerization

An autoclave having an inner volume of 270L and equipped with an agitator was continuously charged with liquid propylene, ethylene, hydrogen and triisobutyl aluminum (TIBA) at 37 kg/hour, 600 g/hour, 0.3 g/hour and 9 g/hour, respectively. The mixture, kept at 70° C., was continuously incorporated with a given quantity of liquid paraffin (Tonen, Whitelex 335) slurry as the preliminary polymerization catalyst, to prepare the propylene/ethylene random copolymer (PP1).

(Production Example 2 for Producing Propylene Polymer)

The propylene/ethylene random copolymer (PP2) was prepared in the same manner as in PRODUCTION EXAMPLE 1, except that liquid propylene, ethylene and hydrogen were supplied at 41 kg/hour, 1.2 kg/hour and 0.4 g/hour, respectively, and system temperature of 60° C. was adopted.

(Production Example 3 for Producing Propylene Polymer)

(1) Preparation of Catalyst

A preliminary polymerization catalyst was prepared in the same manner as in PRODUCTION EXAMPLE 1 (1) and (2) for producing propylene polymer, except that 2.44 g (3.30 mmols) of (r)-dimethylsilylenebis[1-{2-methyl-4-(4-chlorophenyl) -4H-azulenyl}] hafnium dichloride was used as the sole metallocene compound.

(2) Polymerization

An autoclave having an inner volume of 200L and equipped with an agitator was charged with 45 kg of liquid propylene, to which 24 g of triisobutyl aluminum and 0.4 g of hydrogen were added, and the mixture was kept at 60° C. Then, 1.6 g of the preliminary polymerization catalyst component was carried by argon gas into the autoclave under pressure. The system was heated to 75° C. in 40 minutes, at which the polymerization was carried out for 3 hours, and 100 mL of ethanol was introduced under pressure to terminate the polymerization. The remaining gases were purged, and the product was dried, to prepare the propylene homopolymer (PP3).

(Production Example 4 for Producing Propylene Polymer)

An autoclave having an inner volume of 200L and equipped with an agitator was sufficiently purged with propylene, and charged with 60L of heptane, treated beforehand to remove moisture and oxygen, and then with 16 g of diethyl aluminum chloride and 4.1 g of a titanium trichloride catalyst (M&M), added in a propylene atmosphere kept at 50° C. Propylene and ethylene were added at 5.7 kg/hour and 280 g/hour at 50° C. while keeping hydrogen in the vapor phase at 6.0% by volume for 4 hours, and the polymerization was continued for another one hour. The remaining gases were purged, and the product was filtered and dried, to prepare the ethylene random copolymer (PP4).

(Production Example 5 for Producing Propylene Polymer)

(1) Preparation of Catalyst

A flask sufficiently purged with nitrogen was charged with 200 mL of heptane, treated beforehand to remove moisture and oxygen, and then with 0.4 mols of MgCl₂ and 0.8 mols of Ti(O-n-C₄H₉)4. The reaction was allowed to proceed for 2 hour while the system was kept at 95° C. On completion of the reaction, the effluent was cooled to 40° C., and then incorporated with 48 mL of methyl hydrogen polysiloxane (20 centistokes) to continue the reaction for 3 hours. The solid component produced was washed with heptane. Next, a flask sufficiently purged with nitrogen was charged with 50 mL of heptane, and then with 0.24 mols (as Mg) of the solid component synthesized above. The flask was then charged with a mixture of 25 mL of n-heptane and 0.4 mols of SiCl₄ in 60 minutes while the system was kept at 30° C., and the reaction was allowed to proceed at 90° C. for 3 hours. It was still further charged with a mixture of 25 mL of heptane and 0.016 mols of phthaloyl chloride in 30 minutes while the system was kept at 90° C., and the reaction was allowed to proceed at 90° C. for 1 hour. On completion of the reaction, the effluent was washed with heptane and then incorporated with 0.24 mols of SiCl₄, and the reaction was allowed to further proceed at 100° C. for 3 hours. On completion of the reaction, the effluent was sufficiently washed with n-heptane. A flask sufficiently purged with nitrogen was charged with 50 mL of sufficiently purified heptane, and then with 5 g of the solid component prepared above. Then, 0.81 mL of (CH₃)₃CSi(CH₃)(OCH₃)₂ was brought into contact with the above mixture at 30° C. for 2 hours. On completion of the contact, the effluent was washed with heptane, and the preliminary polymerization was carried out in a flow of propylene, to prepare the solid catalyst.

(2) Polymerization

A 200L (inner volume) autoclave equipped with an agitator was sufficiently purged with propylene and charged with 60L of purified n-heptane, to which 15 g of triethyl aluminum and 2.0 g of the solid catalyst prepared above (as the weight excluding the preliminary polymerized polymer) were added in a propylene atmosphere kept at 55° C. Then, the mixture was heated to 60° C., and incorporated with propylene at 5.8 kg/hour while keeping hydrogen in the vapor phase at 5.8% by volume. Ten minutes later, the mixture was incorporated with ethylene at 240 g/hour to carry out the polymerization for 6 hours. Then, supply of all of the monomers was terminated, but the polymerization was continued for 1 hour. Then, the catalyst was decomposed by butanol and the product was filtered and dried, to prepare the propylene/ethylene random copolymer (PP5).

(Production Example 6 for Producing Propylene Polymer)

A propylene/ethylene/1-butene random copolymer (PP6) was prepared in the same manner as in PRODUCTION EXAMPLE 4, except that 42 g of diethyl aluminum chloride and 10.5 g of the catalyst were charged, hydrogen was kept at 4.5% by volume in the vapor phase, propylene, ethylene and 1-butene were supplied at 10.8 kg/hour, 180 g/hour and 2.0 kg/hour, and the reaction system was kept at 65° C.

(Production Example 7 for Producing Propylene Polymer)

A propylene/ethylene/1-butene random copolymer (PP7) was prepared in the same manner as in PRODUCTION EXAMPLE 5, except that 1.8 g of the catalyst (as the weight excluding the preliminary polymerized polymer) was charged, hydrogen was kept at 6.0% by volume in the vapor phase, propylene and ethylene were supplied at 5.8 kg/hour and 155 g/hour, and 1-butene was supplied at 570 g/hour for 270 minutes after the polymerization was initiated.

(Production Example 8 for Producing Propylene Polymer)

(1) Preparation of Catalyst

A mixture of 400 mL of purified toluene and 14 mL of a 0.5 mols/L toluene solution of triisobutyl aluminum as an organometallic compound was prepared with stirring for 1 minute, to which 14 g of silica-supported methyl aluminoxane (methyl aluminoxane content: 26.6% by weight) as a promoter was added. Then, 270 mL of a 0.5 mmols/L toluene solution of (r)-dimethylsilylenebis[1-{2-methyl-4-(1-naphthyl)indenyl}]zirconium dichloride as a metallocene compound was added to the above mixture, and stirred for 30 minutes at room temperature and for 30 minutes at 65° C. The mixture was cooled to room temperature, distilled under a vacuum to remove the toluene, incorporated with a mixture of 670 mL of hexane and 13 mL of a hexane solution of triisobutyl aluminum, and stirred for 5 minutes. The above mixture was again incorporated with a mixture of 670 mL of hexane and 13 mL of a hexane solution of triisobutyl aluminum, after the supernatant liquid was removed, to prepare the catalyst slurry.

(2) Polymerization

A 200 mL autoclave was charged with 70 mL of a 0.5 mols/L hexane solution of triisobutyl aluminum, 45 kg of propylene, 0.32 g of hydrogen and 700 g of ethylene, and the mixture was heated to 60° C. Then, all of the catalyst prepared above was charged into the autoclave under pressure, and the polymerization was allowed to proceed for 60 minutes, to prepare the propylene/ethylene random copolymer (PP8).

### Example 1

A composition comprising 100 parts of PP1 as the propylene polymer, 1 part of high-density polyethylene having a density of 0.958 g/cm³ and melt index of 20 g/10 minutes (Japan Polychem, NOVATEC HJ 490 Powder) as the polyethylene resin, 0.15 parts of silica having an average diameter of 2.2 μm, pore volume of 1.57 mL/g and wear rate of 4 mg (Mizusawa Industrial Chemicals, Mizukasil P707) as the antiblocking agent, 0.10 parts of a phenol-based antioxidant having a molecular weight of 1178 (Ciba Specialty Chemicals, IRGANOX 1010) as the antioxidant and 0.03 parts of the hydrotalcite compound (Kyowa Chemical, DHT-4A) was prepared by high-speed mixing in a Henschel mixer at room temperature and 750 rpm for 1 minute, and molten at 230° C., kneaded, cooled and pelletized by a double-screw extruder (IKEGAI, PCM30), all part(s) by weight, to prepare the pelletized resin composition.

The resin composition was formed by a T-die film-making unit, including an extruder having an aperture diameter of 65 mm, 700 mm wide T-die, air knife, cooling roll (diameter: 400 mm) and sweeper roll (provided at a film-making distance of 650 mm from the die) under the conditions of resin extrusion temperature: 230° C., air velocity for the air knife: 8 m/second, cooling roll temperature: 35° C. and film production rate: 20 m/minute. The film was immediately corona-treated on one side to have a wetting tension of 42 dynes/cm, and wound to have a roll of the film, 25 μm thick and 600 mm wide. The film characteristics were evaluated. The film was cut to a width of 500 mm by a slitter, continuously sent into a continuous vacuum evaporation unit, where the film was metallized with aluminum on the corona-treated side at 10⁵ Torr, and wound to have a roll of the film metallized on one side, about 500 Å thick and 1000 m long. The metallized film characteristics were evaluated. The results are given in Table 2. As shown, it is found that the primary film is excellent in transparency, resistance to blocking, low-temperature heat-sealing property, wound condition and adhesion properties to the metallizing film, and the metallized surface is excellent in adhesion properties of the metallizing film to the base film, resistance to surface scratching, printability, lamination characteristics and wound condition.

### Examples 2 to 4, and Comparative Examples 1 to 7

The films were prepared and evaluated in the same manner as in EXAMPLE 1, except that the polyethylene resin content and properties were changed, as shown in Table 1. The evaluation results are given in Table 2.

COMPARATIVE EXAMPLE 1 prepared a film showing sweeper roll marks transcribed thereto because of lack of polyethylene resin, and could not give a film of good wound condition.

COMPARATIVE EXAMPLE 2 prepared a film showing no improvement in effect of preventing transcription of sweeper roll marks because of insufficient content of polyethylene resin, and could not give a film of good wound condition.

COMPARATIVE EXAMPLE 3 prepared a film having greatly deteriorated transparency because of excessive content of polyethylene resin, and could not give a good film.

COMPARATIVE EXAMPLE 4 prepared a film having greatly deteriorated transparency because of insufficient level of MI_{B} of the polyethylene resin, and could not give a good film.

COMPARATIVE EXAMPLE 5 prepared a film having greatly deteriorated transparency and showing no improvement in effect of preventing transcription of sweeper roll marks because of insufficient level of MI_{B} and density of the polyethylene resin, and could not give a film of good wound-condition.

COMPARATIVE EXAMPLE 6 prepared a film showing no improvement in effect of preventing transcription of sweeper roll marks because of insufficient density of the polyethylene resin, and could not give a film of good wound condition.

COMPARATIVE EXAMPLE 7 prepared a film having deteriorated resistance to blocking because of insufficient level of MI_{B} of the polyethylene resin, and could give neither a good film of suitable adhesion properties to the metallizing film nor metallized film of good printability or lamination characteristics on the metallized surface.

TABLE 1
(B) Polyethylene-based resin

| | | | | Content | |
|---|---|---|---|---|---|
| | MI_{B} | MI_{B}/MFR_{A} | Density | part(s) | |
| | g/10 min | — | g/cm³ | by weight | |
| EXAMPLE 1 | 20 | 3.28 | 0.958 | 1 | Japan Polychem, NOVATEC HJ 490 Powder |
| EXAMPLE 2 | 20 | 3.28 | 0.958 | 0.5 | Japan Polychem, NOVATEC HJ 490 Powder |
| EXAMPLE 3 | 20 | 3.28 | 0.958 | 5 | Japan Polychem, NOVATEC HJ 490 Powder |
| EXAMPLE 4 | 12 | 1.97 | 0.96 | 1 | Japan Polychem, NOVATEC HJ 580 Powder |
| COMPARATIVE | — | — | — | Not | — |
| EXAMPLE 1 | | | | incorporated | |
| COMPARATIVE | 20 | 3.28 | 0.958 | 0.005 | Japan Polychem, NOVATEC HJ 490 Powder |
| EXAMPLE 2 | | | | | |
| COMPARATIVE | 7 | 1.15 | 0.96 | 8 | Japan Polychem, NOVATEC HJ 560 Powder |
| EXAMPLE 3 | | | | | |
| COMPARATIVE | 0.8 | 0.13 | 0.955 | 1 | Japan Polychem, NOVATEC HY430 Powder |
| EXAMPLE 4 | | | | | |
| COMPARATIVE | 4 | 0.66 | 0.918 | 1 | Japan Polychem, NOVATEC UF420 Powder |
| EXAMPLE 5 | | | | | |
| COMPARATIVE | 20 | 3.28 | 0.925 | 1 | Japan Polychem, NOVATEC UJ580 Powder |
| EXAMPLE 6 | | | | | |
| COMPARATIVE | 2670 | 437.7 | 0.97 | 1 | Mitsui Chemicals, Hiwax 800P |
| EXAMPLE 7 | | | | | |

The other components were (A) PP1, 100 parts, (C) antiblocking agent (Mizusawa Industrial Chemicals, Mizukasil P707), 0.15 parts, (D) antioxidant (Ciba Specialty Chemicals, IRGANOX 1010), 0.10 parts and (E) neutralizer (Kyowa Chemical, DHT-4A), 0.03 parts, all parts by weight.

TABLE 2

| | | | | | | | | Metallized film (metallization suitability) | | | | |
|---|---|---|---|---|---|---|---|---|---|---|---|---|
| | | Primary film | | | | | | | Adhe- | | | |
| | | | | | | HS | | | sion | Wetting | Peel | Wound |
| | Processability | | Outer | Blocking | Tensile | temper- | Wound | | prop- | tension | strength | condi- |
| | SWR mark | HAZE | appearances | properties | modulus | ature | condition | ΔG | erties | dyne/ | g/ | tion |
| | — | % | — | g/10 cm² | MPa | ° C. | — | % | — | cm | 15 mm | — |
| EXAMPLE 1 | ⊚ | 2.5 | ◯ | 500 | 740 | 129 | ◯ | 40 | ◯ | 40 | 125 | ◯ |
| EXAMPLE 2 | ⊚ | 2.4 | ◯ | 500 | 710 | 129 | ◯ | 40 | ◯ | 40 | 125 | ◯ |
| EXAMPLE 3 | ⊚ | 2.7 | ◯ | 400 | 780 | 130 | ◯ | 30 | ◯ | 40 | 120 | ◯ |
| EXAMPLE 4 | ⊚ | 2.6 | ◯ | 500 | 720 | 129 | ◯ | 40 | ◯ | 40 | 125 | ◯ |
| COMPARATIVE | x | 2.8 | ◯ | 600 | 580 | 129 | x | 50 | ◯ | 40 | 130 | x |
| EXAMPLE 1 | | | | | | | | | | | | |
| COMPARATIVE | x | 2.7 | ◯ | 500 | 620 | 129 | x | 40 | ◯ | 40 | 130 | x |
| EXAMPLE 2 | | | | | | | | | | | | |
| COMPARATIVE | ⊚ | 7.2 | ◯ | 300 | 760 | 132 | ◯ | 100 | ◯ | 39 | 120 | ◯ |
| EXAMPLE 3 | | | | | | | | | | | | |
| COMPARATIVE | ⊚ | 6.0 | ◯ | 400 | 720 | 130 | ◯ | 90 | ◯ | 39 | 120 | ◯ |
| EXAMPLE 4 | | | | | | | | | | | | |
| COMPARATIVE | x | 5.0 | ◯ | 500 | 590 | 130 | x | 80 | ◯ | 39 | 125 | x |
| EXAMPLE 5 | | | | | | | | | | | | |
| COMPARATIVE | x | 2.6 | ◯ | 500 | 600 | 129 | x | 50 | ◯ | 40 | 130 | x |
| EXAMPLE 6 | | | | | | | | | | | | |
| COMPARATIVE | ◯ | 2.6 | ◯ | 800 | 720 | 129 | ◯ | 40 | x | <30 | 30 | ◯ |
| EXAMPLE 7 | | | | | | | | | | | | |

### Example 5, and Comparative Examples 8 to 13

The films were prepared and evaluated in the same manner as in EXAMPLE 1, except that the propylene polymer properties were changed, as shown in Table 3. The evaluation results are given in Table 4.

COMPARATIVE EXAMPLE 8 prepared a film having an excessively high heat seal temperature and hence failing to achieve good low-temperature heat-sealing property, because the polymer it used was not random and had a high melting point.

COMPARATIVE EXAMPLE 9 prepared a film having deteriorated resistance to blocking because of excessively high contents of the solubles contained in the propylene/ethylene random copolymer at 20° C. or lower and at 40° C. or lower, and could give neither a good film of suitable adhesion properties to the metallizing film nor metallized film of good printability or lamination characteristics on the metallized surface.

COMPARATIVE EXAMPLE 10 prepared a film having deteriorated resistance to blocking because of an excessively high content and weight-average molecular weight of the solubles contained in the propylene/ethylene random copolymer at 40° C. or lower, and could not give neither a good film of suitable adhesion properties to the metallizing film.

COMPARATIVE EXAMPLE 11 used the propylene/ethylene/butene random copolymer which gave a film having insufficient resistance to blocking and stiffness. The metallized film prepared had insufficient printability or lamination characteristics on the metallized surface because of excessively high content and weight-average molecular weight of the insolubles contained in the propylene/ethylene/butane copolymer at 20° C. or lower, and also had insufficient adhesion properties because of excessively high content and weight-average molecular weight of the solubles contained in the copolymer at 40° C. or lower.

COMPARATIVE EXAMPLE 12 prepared a metallized film having insufficient printability or lamination characteristics on the metallized surface because of excessively high weight-average molecular weight of the solubles contained in the propylene/ethylene/butane copolymer at 20° C. or lower.

COMPARATIVE EXAMPLE 13 prepared a film having sweeper roll marks transcribed thereto because of an insufficient PI level of the propylene/ethylene/butane copolymer and excessively high weight-average molecular weight of the solubles contained in the copolymer at 40° C. or lower, and could not give a film of good wound condition.

TABLE 3
(A) Propylene polymer

| | | | | | Content | Content | Molecular | | | |
|---|---|---|---|---|---|---|---|---|---|---|
| | | | | | of the | of the | weight | | | |
| | | | | | solubles | solubles | of the | | | |
| | | | Ethylene/ | | at | at 40° C. | solubles | Molecular weight | | |
| | MFR_{A} | MI_{B}/ | butene | | 20° C. | or lower | at 20° C. | of the solubles | | |
| | g/ | MFR_{A} | content | Tp | or lower | % by | or lower | at 40° C. or lower | PI | |
| | 10 min | — | % by mol | ° C. | % by weight | weight | — | — | — | |
| EXAMPLE 1 | 6.1 | 3.28 | 2.7/— | 134.8 | 0 | 1.69 | — | 0.7 × 10⁴ | 3.2 | PRODUCTION EXAMPLE 1 |
| | | | | | | | | | | for producing propylene |
| | | | | | | | | | | polymer |
| EXAMPLE 5 | 7.7 | 2.6 | 5.0/— | 124.0 | 0.90 | 2.89 | 1.4 × 10⁴ | 1.3 × 10⁴ | 3.1 | PRODUCTION EXAMPLE 2 |
| | | | | | | | | | | for producing propylene |
| | | | | | | | | | | polymer |
| COMPARATIVE | 6.9 | 2.9 | —/— | 151.2 | 0 | 0 | — | — | 2.6 | PRODUCTION EXAMPLE 3 |
| EXAMPLE 8 | | | | | | | | | | for producing propylene |
| | | | | | | | | | | polymer |
| COMPARATIVE | 6.3 | 3.17 | 5.9/— | 139.9 | 4.26 | 6.45 | 2.9 × 10⁴ | 9.8 × 10⁴ | 4.3 | PRODUCTION EXAMPLE 4 |
| EXAMPLE 9 | | | | | | | | | | for producing propylene |
| | | | | | | | | | | polymer |
| COMPARATIVE | 8.1 | 2.47 | 6.0/— | 137.9 | 1.35 | 3.43 | 5.3 × 10⁴ | 9.0 × 10⁴ | 3.8 | PRODUCTION EXAMPLE 5 |
| EXAMPLE 10 | | | | | | | | | | for producing propylene |
| | | | | | | | | | | polymer |
| COMPARATIVE | 6.5 | 3.08 | 2.6/9.3 | 134.1 | 3.92 | 7.76 | 15 × 10⁴ | 11 × 10⁴ | 4.5 | PRODUCTION EXAMPLE 6 |
| EXAMPLE 11 | | | | | | | | | | for producing propylene |
| | | | | | | | | | | polymer |
| COMPARATIVE | 7 | 2.86 | 3.9/6.4 | 131.5 | 1.86 | 3.65 | 5.8 × 10⁴ | 4.9 × 10⁴ | 3.7 | PRODUCTION EXAMPLE 7 |
| EXAMPLE 12 | | | | | | | | | | for producing propylene |
| | | | | | | | | | | polymer |
| COMPARATIVE | 2.7 | 7.41 | 3.4/— | 132.2 | 0.3 | 1.88 | 1.8 × 10⁴ | 2.3 × 10⁴ | 2.2 | PRODUCTION EXAMPLE 8 |
| EXAMPLE 13 | | | | | | | | | | for producing propylene |
| | | | | | | | | | | polymer |

The other components were (B) polyethylene-based resin (Japan Polychem, NOVATEC HJ 490 Powder), 1 part, (C) antiblocking agent (Mizusawa Industrial Chemicals, Mizukasil P707), 0.15 parts, (D) antioxidant (Ciba Specialty Chemicals, IRGANOX 1010), 0.10 parts and (E) neutralizer (Kyowa Chemical, DHT-4A), 0.03 parts per 100 parts of the propylene polymer, all part(s) by weight.

TABLE 4

| | | | | | | | | Metallized film (metallization suitability) | | | | |
|---|---|---|---|---|---|---|---|---|---|---|---|---|
| | | Primary film | | | | | | | Adhe- | | | |
| | | | | | | HS | | | sion | Wetting | Peel | Wound |
| | Processability | | Outer | Blocking | Tensile | temper- | Wound | | prop- | tension | strength | condi- |
| | SWR mark | HAZE | appearances | properties | modulus | ature | condition | ΔG | erties | dyne/ | g/ | tion |
| | — | % | — | g/10 cm² | MPa | ° C. | — | % | — | cm | 15 mm | — |
| EXAMPLE 1 | ⊚ | 2.5 | ◯ | 500 | 740 | 129 | ◯ | 40 | ◯ | 40 | 125 | ◯ |
| EXAMPLE 5 | ◯ | 2.3 | ◯ | 600 | 510 | 120 | ◯ | 50 | ◯ | 39 | 120 | ◯ |
| COMPARATIVE | ⊚ | 2.8 | ◯ | 400 | 920 | 146 | ◯ | 40 | ◯ | 41 | 130 | ◯ |
| EXAMPLE 8 | | | | | | | | | | | | |
| COMPARATIVE | ◯ | 3.2 | ◯ | 1100 | 560 | 136 | x | 50 | x | 32 | 30 | x |
| EXAMPLE 9 | | | | | | | | | | | | |
| COMPARATIVE | ◯ | 2.8 | ◯ | 900 | 580 | 134 | x | 50 | x | 37 | 100 | x |
| EXAMPLE 10 | | | | | | | | | | | | |
| COMPARATIVE | ◯ | 3.0 | ◯ | 1200 | 500 | 130 | x | 60 | x | <30 | 30 | x |
| EXAMPLE 11 | | | | | | | | | | | | |
| COMPARATIVE | ◯ | 2.8 | ◯ | 700 | 580 | 127 | ◯ | 60 | ◯ | 32 | 40 | ◯ |
| EXAMPLE 12 | | | | | | | | | | | | |
| COMPARATIVE | x | 3.2 | ◯ | 500 | 620 | 126 | x | 50 | ◯ | 39 | 125 | x |
| EXAMPLE 13 | | | | | | | | | | | | |

### Examples 6 to 11, and Comparative Examples 14 to 17

The films were prepared and evaluated in the same manner as in EXAMPLE 1, except that the antiblocking agent content and properties were changed, as shown in Table 5. The evaluation results are given in Table 6.

COMPARATIVE EXAMPLE 14 prepared a film having greatly deteriorated resistance to blocking because of lack of an antiblocking agent, and could not give a film of good wound condition. The metallized film could not be evaluated.

COMPARATIVE EXAMPLE 15 prepared a film having deteriorated transparency and outer appearances because of an excessively high content of the antiblocking agent. These problems resulted in deteriorated resistance of the metallized film to surface scratching.

COMPARATIVE EXAMPLE 16 prepared a film having deteriorated outer appearances because of an excessively large pore volume and insufficient dipersibility of the antiblocking agent.

COMPARATIVE EXAMPLE 17 prepared a film having deteriorated transparency because of an excessively large average particle size of the antiblocking agent, and gave the metallized film having deteriorated resistance to surface scratching.

TABLE 5
(C) Antiblocking agent

| | Average | | | | | | |
|---|---|---|---|---|---|---|---|
| | particle | Pore | Wear | | | | |
| | diameter | volume | rate | | | Content | |
| | μm | ml/g | mg | Shape | Type | parts by weight | |
| EXAMPLE 1 | 2.2 | 1.57 | 4 | Undefined | — | 0.15 | Mizusawa Industrial Chemicals, |
| | | | | | | | Mizukasil P707 |
| EXAMPLE 6 | 2.2 | 1.57 | 4 | Undefined | — | 0.3 | Mizusawa Industrial Chemicals, |
| | | | | | | | Mizukasil P707 |
| EXAMPLE 7 | 2.5 | 1.25 | 15 | Undefined | — | 0.15 | Fuji Silysia Chemical, SYLYSIA 430 |
| EXAMPLE 8 | 3.6 | 1.00 | 10 | Undefined | Treated | 0.15 | GRACE Davison, SILOBLOCK 45 |
| | | | | | with citric | | |
| | | | | | acid | | |
| EXAMPLE 9 | 2.2 | 0.45 | 11 | Spherical | — | 0.15 | Mizusawa Industrial Chemicals, |
| | | | | | | | Mizupearl M204 |
| COMPARATIVE | — | — | — | — | — | Not | — |
| EXAMPLE 14 | | | | | | incorporated | |
| COMPARATIVE | 2.2 | 1.57 | 4 | Undefined | — | 0.8 | Mizusawa Industrial Chemicals, |
| EXAMPLE 15 | | | | | | | Mizukasil P707 |
| COMPARATIVE | 1.9 | 1.90 | 6 | Undefined | — | 0.15 | Nippon Silica Industrial, |
| EXAMPLE 16 | | | | | | | Nipgel BZ-200 |
| EXAMPLE 10 | 3 | 0.44 | 23 | Undefined | — | 0.15 | Fuji Silysia Chemical, SYLYSIA |
| | | | | | | | 730 |
| EXAMPLE 11 | 3 | 0.01 | 104 | Spherical | — | 0.15 | Mizusawa Industrial Chemicals, |
| | | | | | | | Silton JC-30 |
| COMPARATIVE | 8.5 | 1.10 | 9 | Undefined | — | 0.15 | Mizusawa Industrial Chemicals, |
| EXAMPLE 17 | | | | | | | Mizukasil P50 |

The other components were (A) PP1, 100 parts, (B) polyethylene-based resin (Japan Polychem, NOVATEC HJ 490 Powder), 1 part, (D) antioxidant (Ciba Specialty Chemicals, IRGANOX 1010), 0.10 parts and (E) neutralizer (Kyowa Chemical, DHT-4A), 0.03 parts, all part(s) by weight.

TABLE 6

| | | | | | | | | Metallized film (metallization suitability) | | | | |
|---|---|---|---|---|---|---|---|---|---|---|---|---|
| | | Primary film | | | | | | | Adhe- | | | |
| | | | | | | HS | | | sion | Wetting | Peel | Wound |
| | Processability | | Outer | Blocking | Tensile | temper- | Wound | | prop- | tension | strength | condi- |
| | SWR mark | HAZE | appearances | properties | modulus | ature | condition | ΔG | erties | dyne/ | g/ | tion |
| | — | % | — | g/10 cm² | MPa | ° C. | — | % | — | cm | 15 mm | — |
| EXAMPLE 1 | ⊚ | 2.5 | ◯ | 500 | 740 | 129 | ◯ | 40 | ◯ | 40 | 125 | ◯ |
| EXAMPLE 6 | ⊚ | 3.3 | ◯ | 400 | 740 | 129 | ◯ | 50 | ◯ | 39 | 120 | ◯ |
| EXAMPLE 7 | ⊚ | 2.2 | ◯ | 400 | 740 | 129 | ◯ | 70 | ◯ | 40 | 125 | ◯ |
| EXAMPLE 8 | ⊚ | 2.5 | ◯ | 500 | 730 | 128 | ◯ | 60 | ◯ | 40 | 125 | ◯ |
| EXAMPLE 9 | ⊚ | 2.2 | ◯ | 500 | 740 | 128 | ◯ | 60 | ◯ | 40 | 125 | ◯ |
| COMPARATIVE | ⊚ | 1.0 | ◯ | 1200 | 710 | 129 | x | — | — | — | — | — |
| EXAMPLE 14 | | | | | | | | | | | | |
| COMPARATIVE | ⊚ | 6.2 | x | 300 | 720 | 131 | ◯ | 300 | ◯ | 39 | 110 | ◯ |
| EXAMPLE 15 | | | | | | | | | | | | |
| COMPARATIVE | ⊚ | 3.0 | x | 600 | 710 | 130 | ◯ | 70 | ◯ | 40 | 120 | ◯ |
| EXAMPLE 16 | | | | | | | | | | | | |
| EXAMPLE 10 | ⊚ | 1.9 | ◯ | 700 | 710 | 129 | ◯ | 250 | ◯ | 40 | 120 | ◯ |
| EXAMPLE 11 | ⊚ | 1.8 | ◯ | 700 | 700 | 129 | ◯ | 350 | ◯ | 40 | 120 | ◯ |
| COMPARATIVE | ⊚ | 5.1 | x | 400 | 710 | 130 | ◯ | 200 | ◯ | 40 | 120 | ◯ |
| EXAMPLE 17 | | | | | | | | | | | | |

### Examples 12 to 15, and Comparative Examples 18 to 21

The films were prepared and evaluated in the same manner as in EXAMPLE 1, except that the antioxidant and neutralizer contents and properties were changed, as shown in Table 7. The evaluation results are given in Table 8.

COMPARATIVE EXAMPLE 18 prepared a film having the phenol-based antioxidant bleeding out on the surface because of its excessively high content, deteriorating adhesion properties to the metallizing film, and printability and lamination characteristics of the metallized surface.

COMPARATIVE EXAMPLE 19 prepared a film having the phenol-based antioxidant bleeding out on the surface because of its insufficient molecular weight, deteriorating adhesion properties to the metallizing film, and printability and lamination characteristics of the metallized surface.

COMPARATIVE EXAMPLE 20 prepared a film having deteriorated transparency and outer appearances because of an excessive content of the hydrotalcite compound, and gave the metallized film having slightly deteriorated resistance to surface scratching.

COMPARATIVE EXAMPLE 21 prepared a film having deteriorated wetting tension, caused by the incorporated calcium stearate, deteriorating adhesion properties to the metallizing film, and printability and lamination characteristics of the metallized surface.

TABLE 7

| | (D) Antioxidant | | | | (E) Neutralizer | |
|---|---|---|---|---|---|---|
| | | Phosphorous- | parts by | | parts by | |
| | Phenol-based | based | weight | Compound name | weight | |
| EXAMPLE 1 | IRGANOX 1010 | — | 0.10 | Hydrotalcite | 0.03 | Kyowa Chemical, DHT-4A |
| EXAMPLE 13 | AO80 | — | 0.10 | Hydrotalcite | 0.03 | Kyowa Chemical, DHT-4A |
| EXAMPLE 14 | — | IRGAFOS 168 | 0.10 | Hydrotalcite | 0.03 | Kyowa Chemical, DHT-4A |
| EXAMPLE 15 | IRGANOX 1010 | IRGAFOS 168 | 0.05/0.05 | Hydrotalcite | 0.03 | Kyowa Chemical, DHT-4A |
| COMPARATIVE | IRGANOX 1010 | — | 0.60 | Hydrotalcite | 0.03 | Kyowa Chemical, DHT-4A |
| EXAMPLE 18 | | | | | | |
| COMPARATIVE | AO40 | — | 0.10 | Hydrotalcite | 0.03 | Kyowa Chemical, DHT-4A |
| EXAMPLE 19 | | | | | | |
| COMPARATIVE | IRGANOX 1010 | — | 0.10 | Hydrotalcite | 0.6 | Kyowa Chemical, DHT-4A |
| EXAMPLE 20 | | | | | | |
| EXAMPLE 16 | IRGANOX 1010 | — | 0.10 | Hydrotalcite | 0.03 | Kyowa Chemical, ZHT-4A |
| COMPARATIVE | IRGANOX 1010 | — | 0.10 | Calcium stearate | 0.03 | Kosei, Ca-St |
| EXAMPLE 21 | | | | | | |

The other components were (A) PP1, 100 parts, (B) polyethylene-based resin (Japan Polychem, NOVATEC HJ 490 Powder), 1 part and (C) antiblocking agent (Mizusawa Industrial Chemicals, Mizukasil P707), 0.15 parts, all part(s) by weight.
IRGANOX 1010: Ciba Specialty Chemicals, molecular weight: 1178
AO80: ASAHI DENKA, molecular weight: 741
AO40: ASAHI DENKA, molecular weight: 383
IRGAFOS 168, Ciba Specialty Chemicals, molecular weight: 647

TABLE 8

| | | | | | | | | Metallized film (metallization suitability) | | | | |
|---|---|---|---|---|---|---|---|---|---|---|---|---|
| | | Primary film | | | | | | | Adhe- | | | |
| | | | | | | HS | | | sion | Wetting | Peel | Wound |
| | Processability | | Outer | Blocking | Tensile | temper- | Wound | | prop- | tension | strength | condi- |
| | SWR mark | HAZE | appearances | properties | modulus | ature | condition | ΔG | erties | dyne/ | g/ | tion |
| | — | % | — | g/10 cm² | MPa | ° C. | — | % | — | cm | 15 mm | — |
| EXAMPLE 1 | ⊚ | 2.5 | ◯ | 500 | 740 | 129 | ◯ | 40 | ◯ | 40 | 125 | ◯ |
| EXAMPLE 13 | ⊚ | 2.5 | ◯ | 500 | 740 | 129 | ◯ | 40 | ◯ | 39 | 120 | ◯ |
| EXAMPLE 14 | ⊚ | 2.5 | ◯ | 500 | 730 | 129 | ◯ | 40 | ◯ | 39 | 120 | ◯ |
| EXAMPLE 15 | ⊚ | 2.4 | ◯ | 500 | 730 | 129 | ◯ | 40 | ◯ | 39 | 120 | ◯ |
| COMPARATIVE | ⊚ | 2.4 | ◯ | 600 | 700 | 130 | ◯ | 50 | x | <30 | 30 | ◯ |
| EXAMPLE 18 | | | | | | | | | | | | |
| COMPARATIVE | ⊚ | 2.4 | ◯ | 600 | 710 | 129 | ◯ | 50 | x | <30 | 30 | ◯ |
| EXAMPLE 19 | | | | | | | | | | | | |
| COMPARATIVE | ⊚ | 4.2 | x | 400 | 720 | 131 | ◯ | 200 | ◯ | 40 | 120 | ◯ |
| EXAMPLE 20 | | | | | | | | | | | | |
| EXAMPLE 16 | ⊚ | 2.5 | ◯ | 500 | 730 | 129 | ◯ | 40 | ◯ | 40 | 125 | ◯ |
| COMPARATIVE | ⊚ | 2.4 | ◯ | 600 | 710 | 130 | ◯ | 50 | x | <30 | 30 | ◯ |
| EXAMPLE 21 | | | | | | | | | | | | |

The metallized film of the polypropylene-based resin composition of the present invention for metallized films is excellent in processability, stiffness, heat-sealing property, resistance to blocking and surface scratching, adhesion properties of the metallizing film to the base film, and printability and lamination characteristics of the metallized surface. The polypropylene-based resin composition for metallized films and the metallized film thereof are suitable particularly for wrapping in the food and medical areas.

What is claimed is:

1. A polypropylene-based resin composition for metallized films, comprising:
(A) 100 parts by weight of a propylene random copolymer having the properties (a-1) to (a-5):
(a-1) propylene unit present at 88 to 99.5% by mol, and ethylene and/or butene structural unit present at 0.5 to 12% by mol,
(a-2) melt flow rate (MFR_{A}) of 1 to 30 g/10 minutes,
(a-3) polydispersity index (PI), determined by the melt viscoelasticity analysis, of 2.4 to 4,
(a-4) solubles contained at 20° C. or lower, determined by cross fractionation chromatography (CFC), at 1.5% by weight or less, and the solubles having a weight-average molecular weight of 0.1×10⁴ to 6.0×10⁴, and
(a-5) solubles contained at 40° C. or lower, determined by cross fractionation chromatography (CFC), at 4.0% by weight or less, and the solubles having a weight-average molecular weight of 0.1×10⁴ to 8.0×10⁴,
(B) 0.01 to 6 parts by weight of a polyethylene resin having a density of 0.945 to 0.980 g/cm³, melt index (MI_{B}) of 1 to 1000 g/10 minutes, and ratio of MI_{B} to MFR_{A}, i.e., (MI_{B}/MFR_{A}) ratio, of 0.7 to 1000,
(C) 0.01 to 0.7 parts by weight of an antiblocking agent having an average particle size of 1.0 to 5.0 μm and pore volume of 1.7 mL/g or less,
(D) 0.01 to 0.5 parts by weight of an antioxidant having a molecular weight of 500 or more, and
(E) 0.005 to 0.5 parts by weight of a hydrotalcite-based compound.

2. The polypropylene-based resin composition according to claim 1 for metallized films, wherein said propylene random copolymer (A) further has the property (a-6), and antiblocking agent (C) has a pore volume of 0.45 mL/g or more and wear rate of 100 mg or less:
(a-6) melting point (Tp), determined by differential scanning calorimetry (DSC), of 115 to 150° C.

3. The polypropylene-based resin composition according to claim 1 or 2 for metallized films, wherein said antioxidant (D) is a phenol- and/or phosphorus-based one.

4. The polypropylene-based resin composition according to one of claims 1 to 3 for metallized films, wherein said propylene random copolymer (A) is produced in the presence of a metallocene catalyst.

5. A film for metallization, composed of the polypropylene-based resin composition according to one of claims 1 to 4 for metallized films.

6. The film according to claim 5 for metallization, satisfying the following relationship:
730≦14×[HST]−[YM]≦1340 (1)
(wherein, [HST] is a heat seal temperature (unit: ° C.) at which the load is 3N, and [YM] is a tensile modulus (unit: MPa) of the film).

7. A metallized film comprising the film according to claim 5 or 6 for metallization, metallized with a metal and/or its oxide.
